(19) United States
(12) Patent Application Publication
(10) Pub. No.: US 2015/0121832 A1
(43) Pub. Date: May 7, 2015

(54) ADJUSTMENT MECHANISM FOR LAWN MOWER DECK ATTACHED TO A TRACTOR

(71) Applicant: Amerequip Corporation, Kiel, WI (US)

(72) Inventors: Mark J. Nier, Chilton, WI (US); Joseph Levi Paulik, Oshkosh, WI (US)

(73) Assignee: Amerequip Corporation, Kiel, WI (US)

(21) Appl. No.: 14/529,980

(22) Filed: Oct. 31, 2014

Related U.S. Application Data
(60) Provisional application No. 61/898,645, filed on Nov. 1, 2013.

(51) Int. Cl. A01D 34/01; A01D 34/00

(52) U.S. Cl. CPC A01D 34/015; A01D 34/006; A01D 2101/00
USPC 56/320.1

(57) ABSTRACT

A height adjustment mechanism for a tractor mounted lawn mower deck has a rotatable dial adjuster that moves a cam having a plurality of bearing surfaces engaged by the adjustment mechanism.

### CROSS-REFERENCE TO RELATED APPLICATION

This application is based on and claims priority to U.S. Provisional Patent Application No. 61/898,645 filed on Nov. 1, 2013, which is incorporated herein by reference in its entirety for all purposes.

### FIELD OF THE INVENTION

The present invention relates generally to the field of lawn mower decks that are attached to tractors. More particularly, the present invention relates to an adjustable height lawn mower deck for a tractor having a three point hitch.

### BACKGROUND

Owners of agricultural tractors are commonly able to mow grass by attaching a lawn mower deck under the tractor. Typical lawn mower decks include a height adjustment mechanism that allows the tractor operator to adjust the height of the lawn mower deck, and thereby adjust the length of cut of the grass. Many such height adjustment mechanisms are operable while the operator is sitting on the tractor and typically include a handle within a linear track having detents that correspond to different cut heights. The linear movement of the handle causes such height adjustment mechanisms to be susceptible to unintended and undesired changes to the cut height setting due to vibration of the tractor as it rides over uneven surfaces or inadvertent operator contact with the handle. Other existing height adjustment mechanisms are foot pedal actuated, wherein an operator selects a desired height of cut by pressing on a pedal attached to a bar within a linear track having detents that correspond to different cut heights.

Various attempts have been made to prevent such unintended changes to the cut height setting, including revised detent designs, adjustment mechanisms using cams to adjust height, and rotary detent systems. Some of these systems involve the use of tools and other systems have foregone adjustment by the operator from the operator's seat entirely, instead employing a system that solves the problem of unintended adjustment, but necessitates leaving the operator's seat and removing and replacing a pin from a bracket to set the height of cut.

As such, there is a need for a mower deck height adjustment mechanism that is not susceptible to unintended and undesired changes to the cut height, and may be adjusted by the operator from the operator's seat without the use of tools.

### BRIEF DESCRIPTION OF THE DRAWINGS

FIG. 1 is a side schematic view of a prior art adjustable height lawn mower deck attached to a tractor;

FIG. 2 is a perspective view of the prior art adjustable height lawn mower deck of FIG. 1;

FIG. 3 is a perspective view of one embodiment of an adjustable height lawn mower deck in accordance with the invention showing the lawn mower deck attached to a tractor chassis;

FIG. 4 is another perspective view of the adjustable height lawn mower deck of FIG. 3 showing the lawn mower deck adjustment mechanism and tractor rockshaft arms separate from the other components of the tractor and lawn mower deck;

FIG. 5 is a detail view of the adjustable height lawn mower deck of FIG. 3 showing the dial height selector;

FIG. 6 is a detail perspective view of the adjustable height lawn mower deck of FIG. 3 showing the operation of the dial height selector;

FIG. 7 is another detail perspective view of the adjustable height lawn mower deck of FIG. 3;

FIG. 8 is a side schematic view of one embodiment of a dial height selector in accordance with the invention showing the dial in a locked and unlocked position;

FIG. 9 is an exploded perspective view of the dial height selector of FIG. 8;

FIG. 10 is a detail perspective view of the dial height selector of FIG. 8 showing a collar and pin in a retracted position, which allows rotation of the dial; and

FIG. 11 is a front view of one embodiment of a base plate of the dial height selector of FIG. 8.

### SUMMARY

The present invention relates to an adjustment mechanism for adjusting the height of cut of a lawn mower attachment for a tractor having a three point hitch. The lawn mower deck is removably attached to the tractor by a height adjustment linkage. The height adjustment linkage includes a rockshaft bracket removably attached to a rockshaft arm of the three point hitch. The height adjustment linkage also includes a height bar that is selectively engaged with a rotatable cam. The rotatable cam is connected to a camshaft passing through a hole in an adjustment plate and having an adjustment dial at a first end. The adjustment dial is mounted to the tractor, preferably within reaching distance of the tractor operator when seated in an operator's seat. The rotatable cam has a plurality of bearing surfaces, each of which correspond to a different height of cut. The height bar is engaged with one of the plurality of bearing surfaces when the rockshaft arms are in a lowered position and disengaged when the rockshaft arms are in a raised position. The adjustment plate is mounted to the tractor and includes a plurality of holes that align the bearing surfaces with the height bar when a locking pin attached to the adjustment dial is engaged with one of the plurality of holes.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### DETAILED DESCRIPTION

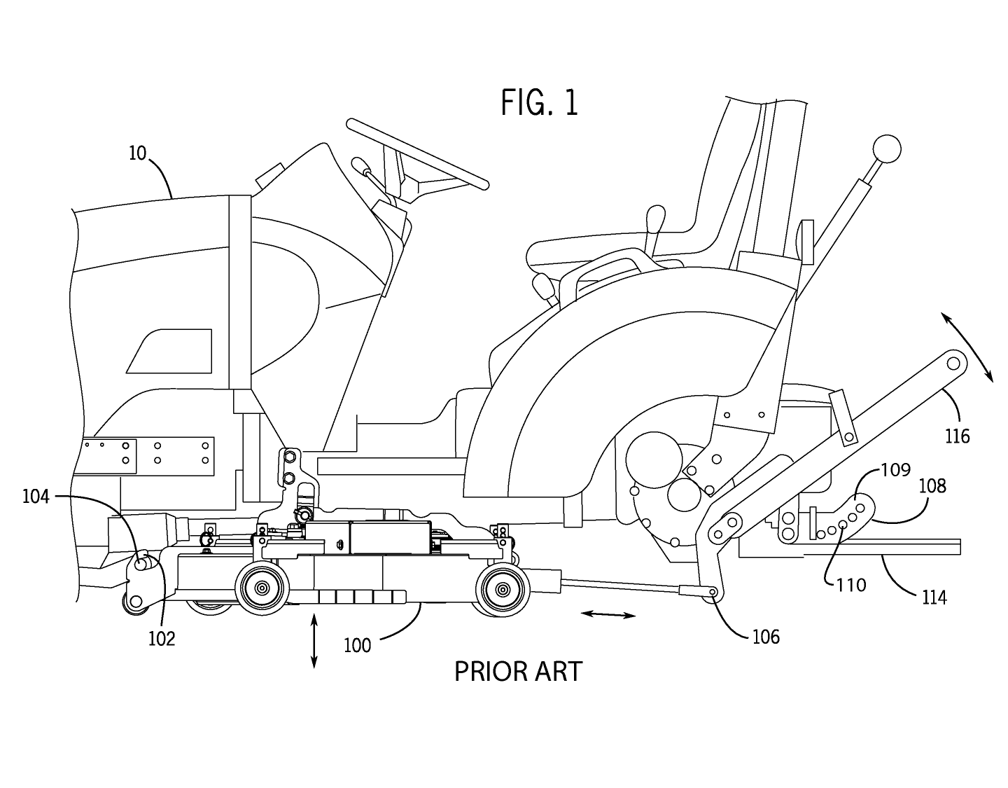

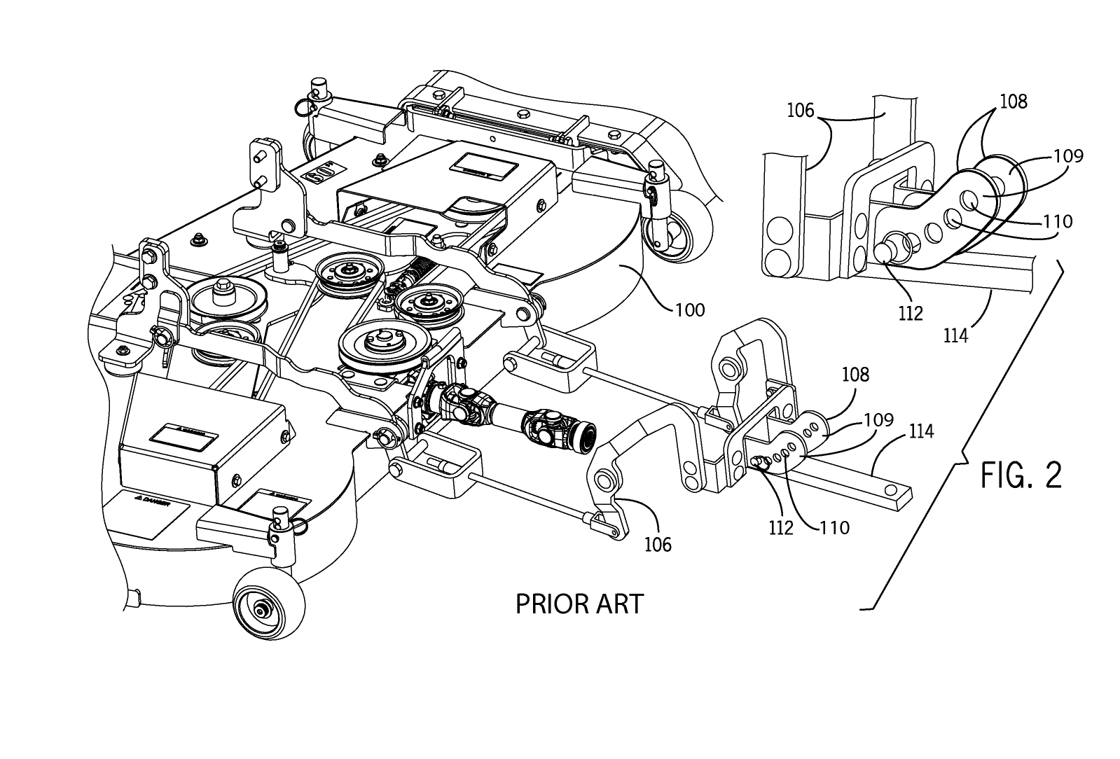

The present invention relates to a lawn mower deck attachment for a tractor, wherein the height of cut may be adjusted by a tractor operator using a dial height selector. FIGS. 1-2 show one example of a prior art height adjustable lawn mower deck attachment 100 for a tractor 10. The example shown in FIGS. 1-2 is one attempt to prevent the unwanted height of cut adjustment that are typical of detent-based adjustment mechanisms. The prior art height adjustable mower deck attachment 100 is mounted under the tractor 10 and is attached to the tractor by hooks 102 that engage pins 104 on the tractor, and an adjustable linkage 106. The hooks 102 and pins 104 are typical of tractors that accommodate multiple attachments, and allow mower decks to be attached and removed from the tractor easily and with a minimum of tools. The adjustable linkage 106 has an adjustment mechanism 108 located at the rear of the tractor 10. The adjustment mechanism 108 includes two adjustment plates 109, each of which includes a plurality of holes 110 through which a height adjustment pin 112 is inserted to set the cut height of the lawn mower deck attachment 100. The height adjustment pin 112 rests on a tow bar 114 when the tractor is in operation.

To adjust the height of cut, an operator first raises the tractor's rockshaft arms, which in turn raise three point hitch arms 116, which engage the adjustable linkage 106 causing the height adjustment pin 112 to raise off of the tow bar 114, thereby allowing the pin to be removed and replaced in a new hole 110. Thus, in order perform the height of cut adjustment using the prior art height adjustable lawn mower deck attachment 100, the tractor operator must raise the rockshaft arms so the height adjustment pin 112 is disengaged from the tow bar 114, exit the seat of the tractor and walk to the location of the adjustment mechanism 108, remove the height adjustment pin from the adjustment mechanism, adjust the position of the adjustment mechanism, replace the height adjustment pin, return to the seat of the tractor, and finally lower the rockshaft arms so that the height adjustment pin re-engages the tow bar. This is a cumbersome process that is time consuming, may require tools, and may also be physically strenuous.

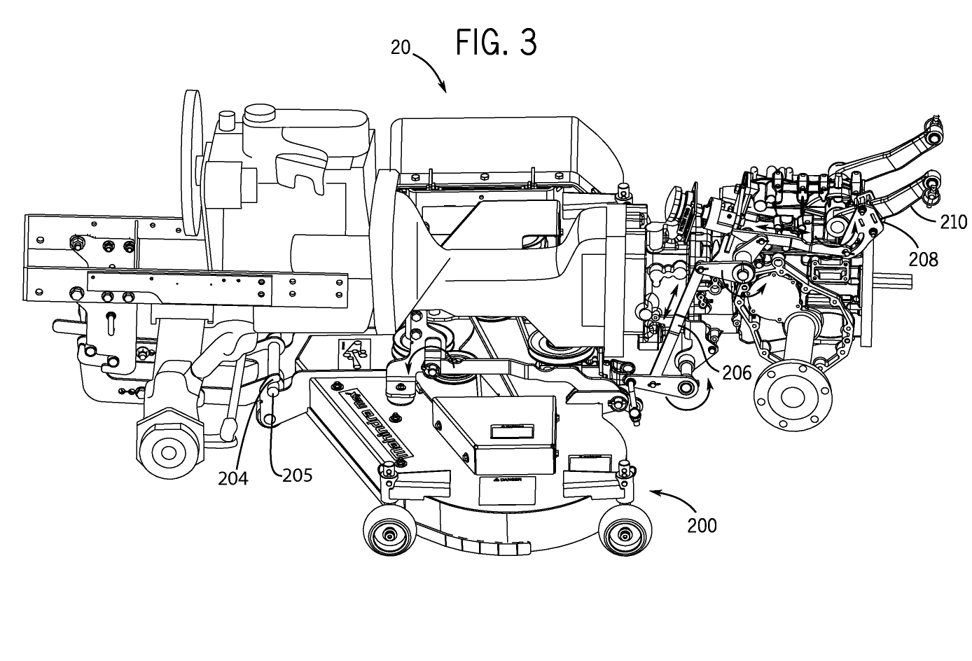

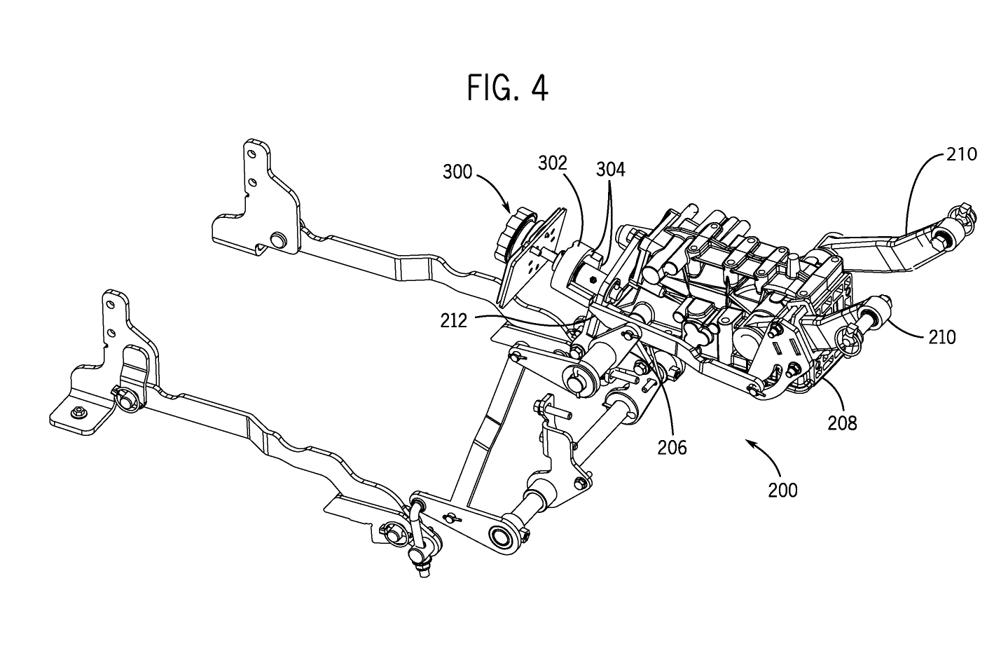

Turning now to FIGS. 3-4, one embodiment of a lawn mower deck attachment 200 in accordance with the invention is shown. As shown in FIG. 3, the lawn mower deck attachment 200 is attached to a tractor chassis 20 by a plurality of hooks 204 that engage pins 205 on the tractor chassis, and an adjustable linkage 206. As is typical of most agricultural tractors, the tractor chassis 20 includes a three point hitch for attaching accessory implements. The three point hitch includes two rockshaft arms 210 that may be raised or lowered by the operator.

The adjustable linkage 206 includes a rockshaft bracket 208 that is removably attached to one of the rockshaft arms 210 of the tractor's three point hitch by two plates 209 and a plurality of nuts 211 and bolts 213. Of course, any other suitable attachment means may be used without departing from the invention. The adjustable linkage 206 translates movement of the rockshaft arm 210 to selectively engage a height bar 212 with a dial adjuster 300, which allows an operator to adjust the height of cut of the mower deck attachment 200 without tools and without leaving the seat of the tractor.

During normal operation of the lawn mower deck attachment 200, the operator positions the rockshaft arm 210 in a lowered position, which causes height bar 212 to engage dial adjuster 300 and thereby set the height of cut. The movement of the rockshaft arm 210 is typically controlled by the tractor operator while sitting in the seat of the tractor. Similarly, the dial adjuster 300 is installed on the tractor 20 so that it may also be operated by the operator while sitting in the seat of the tractor. Of course, the dial adjuster 300 may be located in any suitable location without departing from the invention, but placing the dial within reaching distance of the operator is the preferred location.

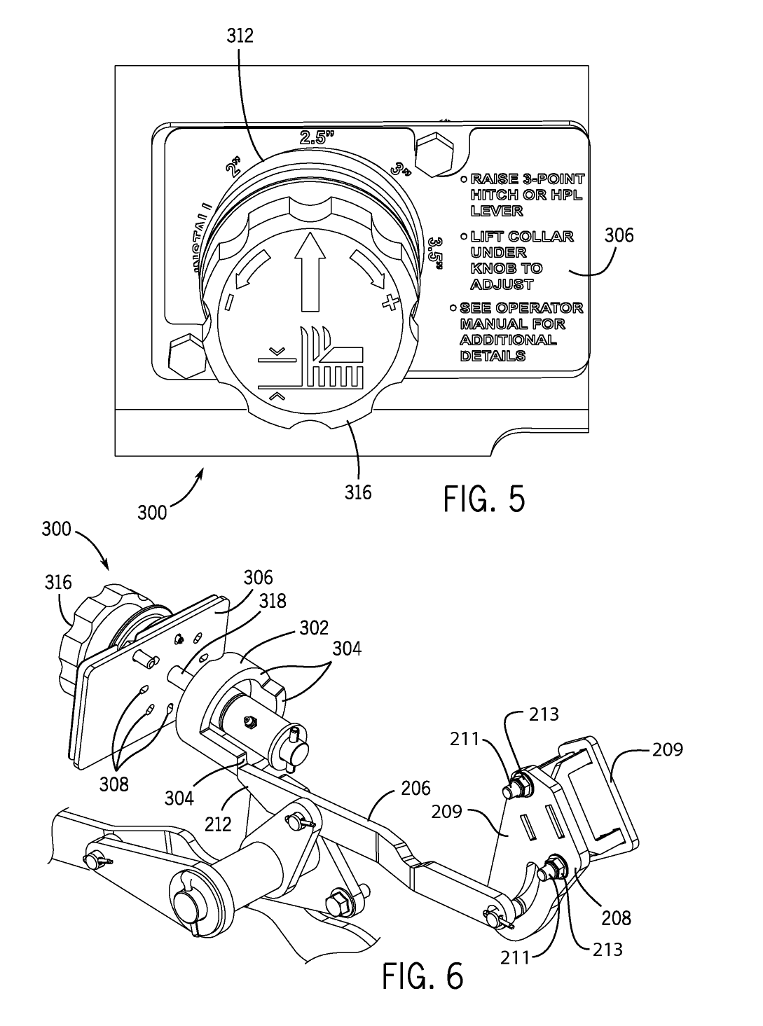

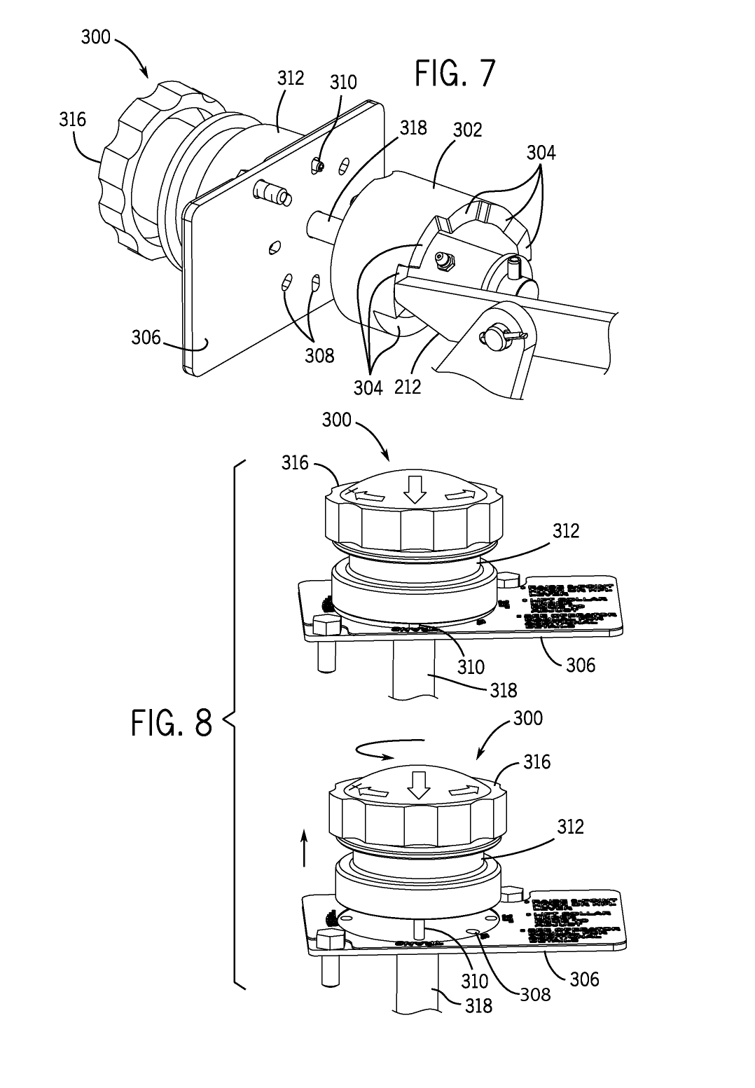

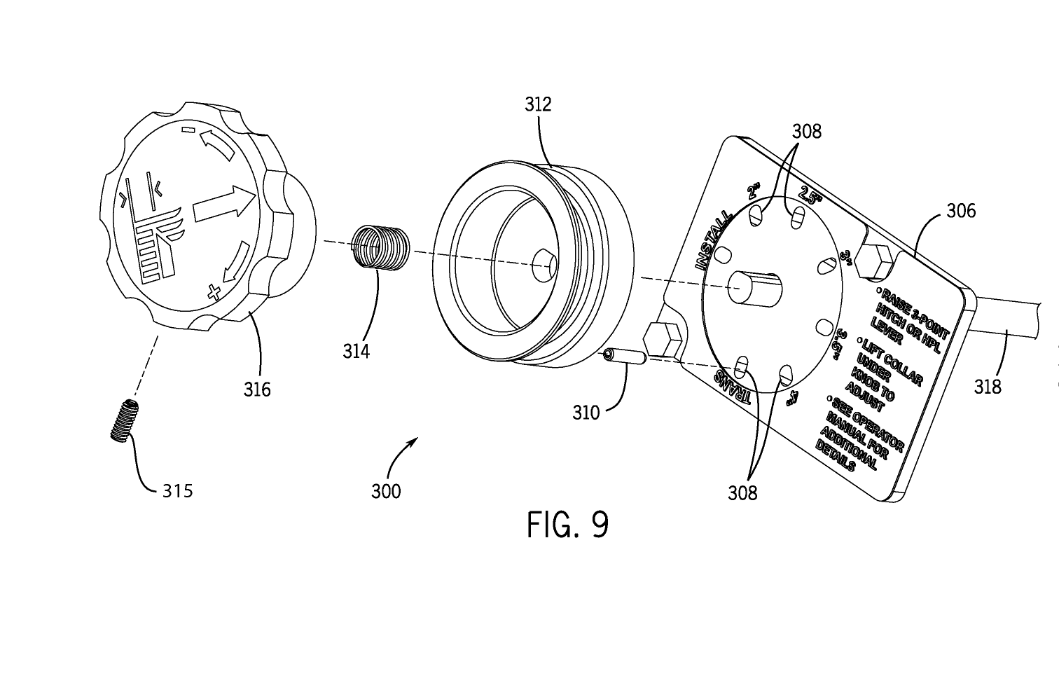

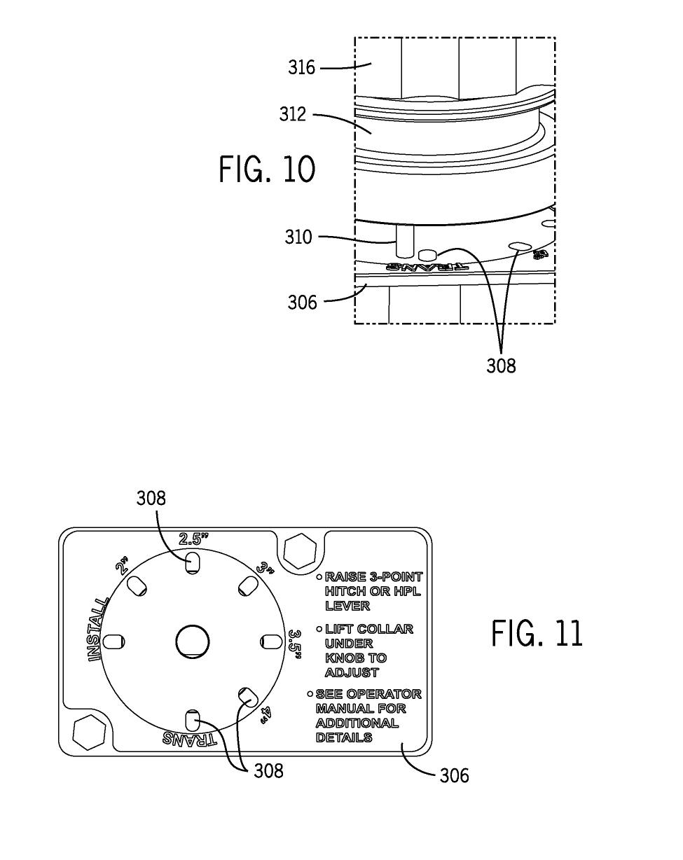

Turning now to FIGS. 5-11, the operation of the dial adjuster 300 is shown. The dial adjuster 300 is preferably mounted near the seat of the tractor so that it may be used while the tractor operator is sitting in the seat of the tractor. The dial adjuster 300 includes a cam 302 is that is actuated by rotation of the dial adjuster 300. As shown, cam 302 includes a plurality of bearing surfaces 304, each of which corresponds to a particular height of cut. When the operator selects a particular height of cut, the corresponding bearing surface 304 is aligned with a height bar 212, which is one of the components of the adjustable linkage 206. When the rockshaft arm 210 is in a raised position, the height bar 212 disengages the bearing surface 304, thereby allowing the cam 302 to rotate freely when the operator moves the dial adjuster 300. When the operator has positioned the cam 302 for the desired height of cut, he simply lowers the rockshaft arm 210 to re-engage the height bar 212 with the corresponding bearing surface 304.

The dial adjuster 300 further includes a plate 306 having a plurality of holes 308 that are indexed to a particular bearing surface 304 and a pin 310 attached to a collar 312 that selectively engages one of the holes to set the cut height. In the embodiment shown, the collar 312 is spring loaded to prevent the pin 310 from inadvertently disengaging the hole 308. A spring 314 is captured between the collar 312 and a dial 316, which is fixed to a camshaft 318. A set screw 315 secures the dial 316 to the collar 316, but any other suitable means may alternatively be used. The camshaft 318 is attached to the cam 302 and rotates the cam when the dial 316 is rotated by the tractor operator. To disengage the pin 310 from the hole 308, the operator simply pulls up on the collar, thereby allowing the dial to freely rotate. Alternatively, the collar 312 and dial 316 may be combined as a single component, the dial including the pin 310, so that an operator would simply lift the dial itself, which would disengage the pin 310 from the hole 308, thereby allowing the dial to freely rotate. In such an alternative embodiment, a spring attached to the crankshaft 318 may bias the dial 316 toward the plate 306. The dial 316 may or may not be biased toward the plate 306 by a spring or any other suitable means without departing from the invention.

FIG. 11 shows the plate 306 in greater detail, showing the various labeling of cut height adjustment that may be set in the embodiment shown. Of course, the dial adjuster 300 may be calibrated with as few or as many holes 308 as are desired, and may further be calibrated to adjust cut height across a broad range of heights without departing from the invention.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A height of cut adjustment mechanism comprising:
a lawn mower deck removably attachable to a tractor having a three point hitch by a height adjustment linkage;
the height adjustment linkage including a height bar and a rockshaft bracket removably attached to a rockshaft arm of the three point hitch;
a rotatable cam connected to a camshaft passing through a hole in an adjustment plate and having an adjustment dial at a first end, the adjustment dial mounted to the tractor;
the rotatable cam having a plurality of bearing surfaces selectively engaged with the height bar, each of the bearing surfaces corresponding to a different height of cut;
the height bar engaged with a bearing surface when the rockshaft arm is in a lowered position and disengaged with a bearing surface when the rockshaft arm is in a raised position;
the adjustment plate mounted to the tractor and including a plurality of height of cut adjustment holes that align bearing surfaces with the height bar; and
a locking pin attached to the adjustment dial, the locking pin selectively engaged with one of the plurality of height of cut adjustment holes.

2. The height of cut adjustment mechanism of claim 1, wherein the locking pin is attached to a spring loaded collar located between the adjustment dial and the adjustment plate.

3. The height of cut adjustment mechanism of claim 1, wherein the adjustment dial is biased toward the adjustment plate by a spring.

4. The height of cut adjustment mechanism of claim 1, wherein the adjustment dial is positioned within reaching distance of an operator's seat.

5. A method of adjusting a height of cut for a lawn mower deck attached to a tractor having a three point hitch including rockshaft arms, wherein the tractor includes a height of cut adjustment mechanism having a height adjustment linkage removably attached to the rockshaft arms and the lawn mower deck, a height bar, an adjustment dial having a locking pin, a cam, and an adjustment plate having a plurality of height of cut adjustment holes, comprising the steps of:
disengaging the height bar from a first bearing surface of the cam by raising the rockshaft arms;
disengaging the locking pin from one of the height of cut adjustment holes; rotating the adjustment dial to align the locking pin with the height of cut adjustment hole that corresponds to the desired height of cut, which also aligns a second bearing surface with the height bar;
releasing the adjustment dial, which causes the locking pin to engage one of the adjustment holes; and
lowering the rockshaft arms to re-engage the height bar with the second bearing surface.

6. The method of adjusting a height of cut of claim 5 further including the step of:
disengaging the locking pin from one of the height of cut adjustment holes by pulling the adjustment dial away from the adjustment plate.
